(19) United States
(12) Patent Application Publication
(10) Pub. No.: US 2012/0002005 A1
(43) Pub. Date: Jan. 5, 2012

(54) Method and apparatus for the wireless operation of a scaled tank in real time

(76) Inventor: John S. Roberts, Burlington, NC (US)

(21) Appl. No.: 13/149,778

(22) Filed: May 31, 2011

Related U.S. Application Data
(60) Provisional application No. 61/349,942, filed on May 31, 2010.

(51) Int. Cl. H04W 4/00; H04N 7/00

(52) U.S. Cl. 348/36; 370/338; 348/E07.001

(57) ABSTRACT

A method for real time control of a scale model tank over a wireless network. Whereby a wireless enabled scaled model tank is controlled by a player using a web browser over a network while listening and viewing the movement of the tank.

### BACKGROUND

Previous to this invention, scaled model remote toy tanks were operated using a hand held transmitter. The user manipulates dials, levers and wheels on the transmitter which sent signals to a receiver on the tank. The tank moves according to the signals. The user has to be within the local range of the receiver, usually within plain view of the tank to control it. The present invention over comes this allowing any person with Internet access the ability to control a scaled model tank in real time.

### BRIEF DESCRIPTION OF DRAWINGS

The invention will be better understood by reference to the following description taken in conjunction with the accompanying drawings.

FIG. 1. shows a top, front and right side perspective view of the invention in its entirely. A scaled model tank, a motherboard with inputs, outputs and Wifi board. A video camera and microphone.

FIG. 2. shows two (2) of the invention in play and a wireless router connected to the internet.

FIG. 3. is a plan view from the tank player web browser, displaying the video showing the tank, scores and controls.

FIG. 4. is a first page of a flow chart detailing the software programming for operation of the invention's on board web server.

FIG. 5. is the second page of the flow chart detailing the software programming for operation of the invention's on board web server.

FIG. 6. is a functional block diagram of the invention's custom motherboard.

### DESCRIPTION

The invention disclosed allows for real time video, sound and the control of a scaled model tank over a wireless network via a web browser.

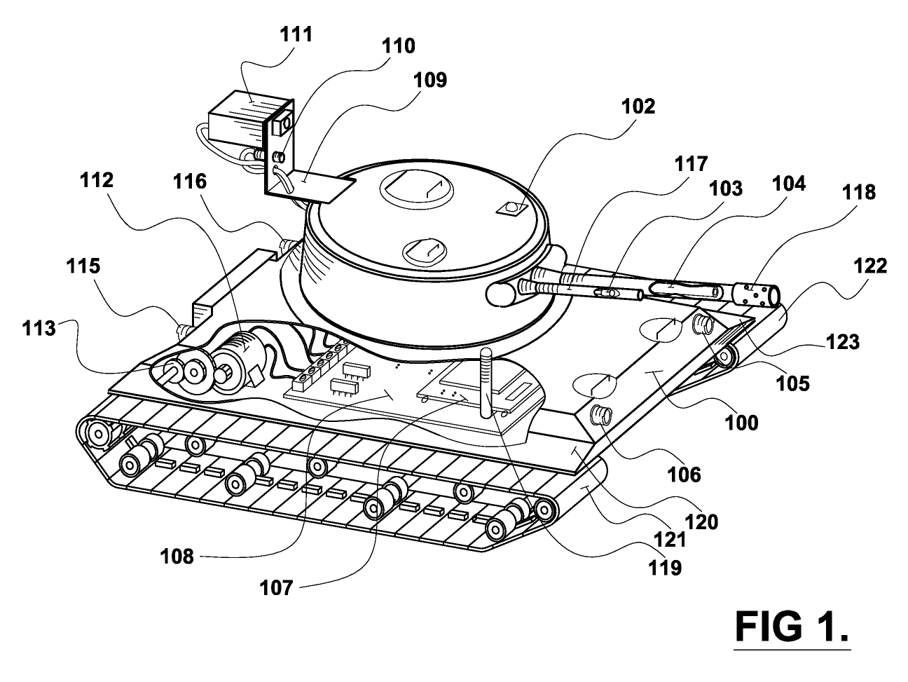

The invention FIG. 1. is constructed using a IEEE 802.11 (WiFi) capable core module 107 encompassing an embedded web server, one such module can be readily obtained from Rabbit Semiconductors model number 5400W. An engineered motherboard 108 is designed allowing the core module to attach. The motherboard encompassess electronic inputs, outputs (I/O) and DC motor controller integrated circuits (IC). It is sized such that it can be mounted and wired into a scaled model tank 100. For ease of production a scaled model tank can be purchased, a 1/16 scale tank can be obtain from Heng Long Co. Attaching a bracket 109, for mounting a camera(s) 111 to view the action, but more important mounting the camera such the front fenders 120, 123 and tracks 122, 121 of the tank are in the picture when the tank travels forward. Typically when driving any type of vehicle it is nearly impossible to maneuver the vehicle, unless the front corners of the vehicle are within the operators view. This lets the player (player A) see between obstacles. Mounting a microphone 110 onto the tank to transmit the sound.

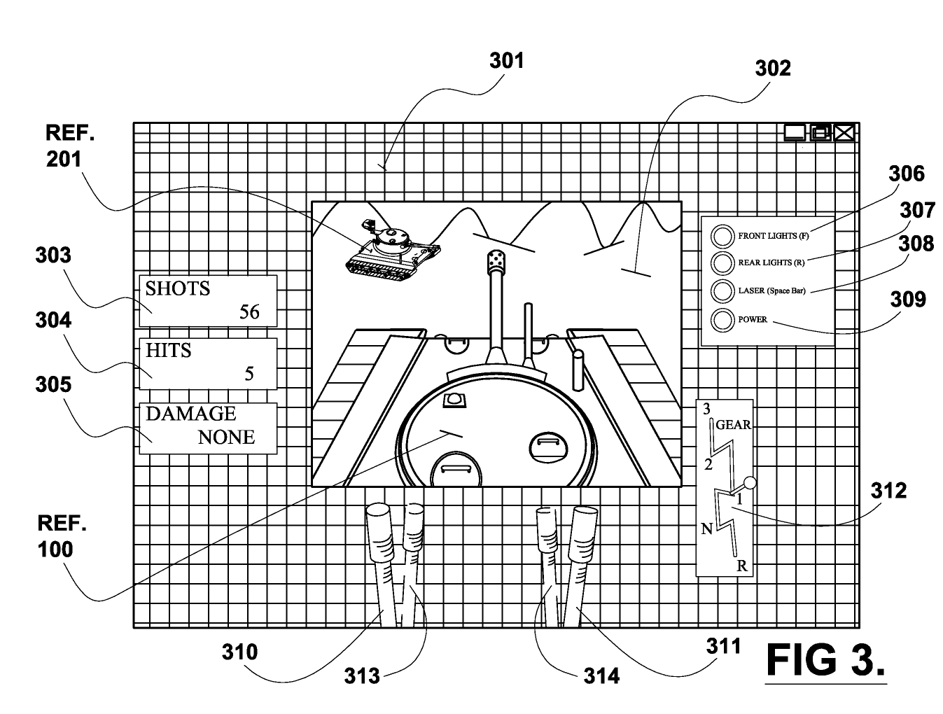

The system allows a player to log onto the server with a web browser FIG. 3. from anywhere in the world and be able to control the tank remotely. The web server is programmed to display a web page 301 which encompasses the video(s) 302 from the camera(s) and sound from the microphone(s). As the player presses keys on their keyboard or clicks links with a mouse the web server receives the requests, the program on the web server, then turns on or off outputs. The outputs can be wired to control a number of options, such as but limited to the front lights 106, 105, rear lights 115, 116, DC power to the camera, other outputs associated with the tank and the drive motors 112. Each motor requires two outputs from the motherboard, programming for the two outputs per the recommendation allows the tank track motors to rotate gears and drive shafts 113 clockwise or anti-clockwise allowing the tank to move forward or backwards. Programming the server to stop one track while running the other causes the tank to turn or spin. Another DC motor IC can be used to rotate the tank turret in either direction. Yet another motor IC could be used to raise or lower the gun. While additional inputs are available for other features of the tank.

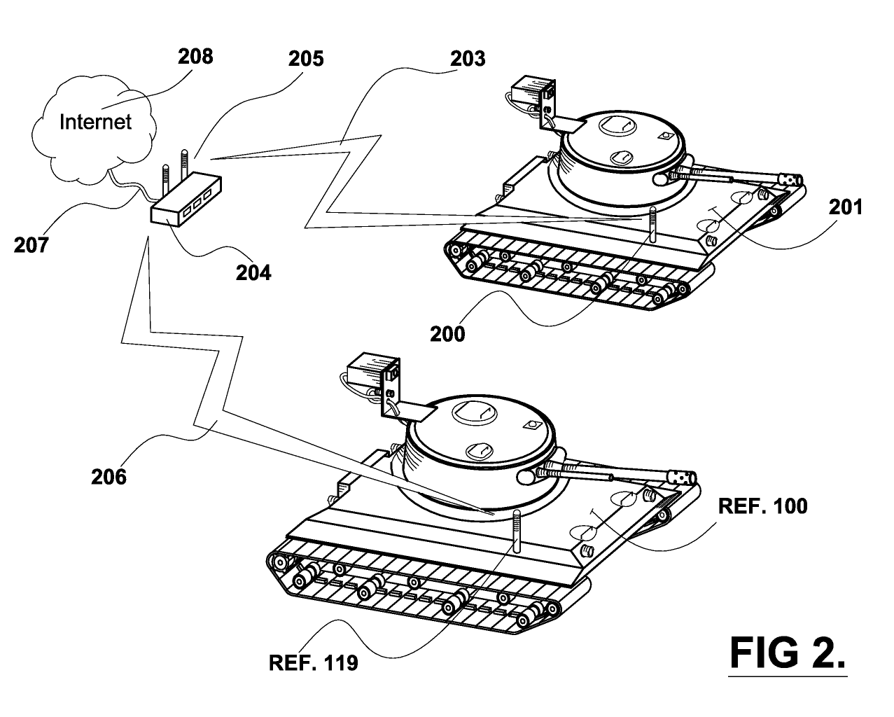

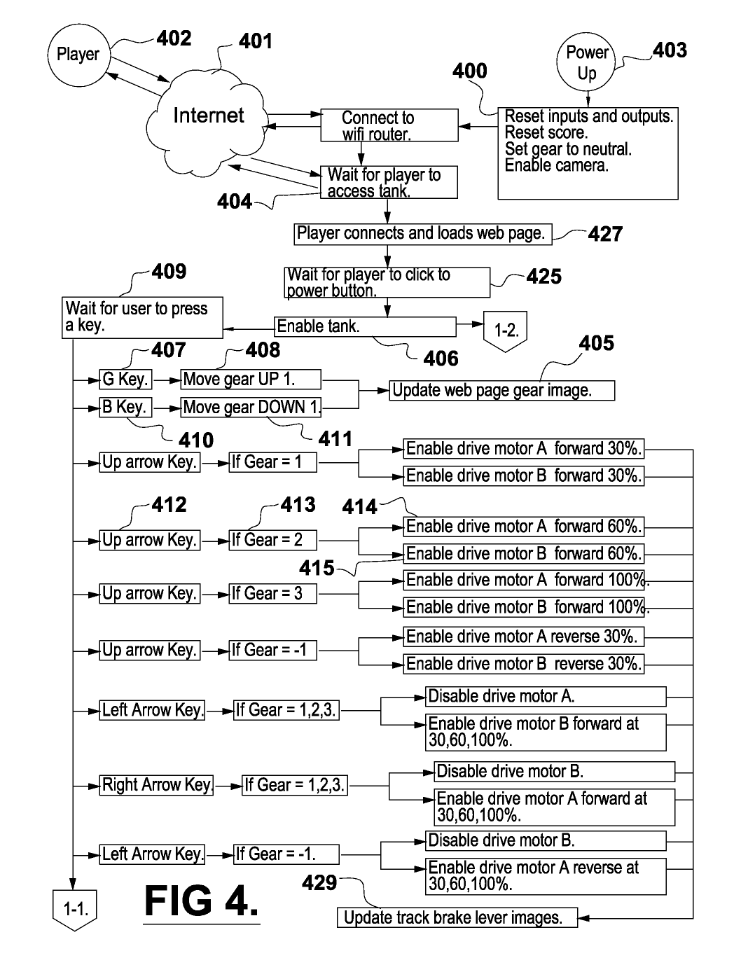

The invention FIG. 4. upon power up 403, resets all inputs and outputs 400 to know states, sets the scores to zero, enables the camera and sets the gear to neutral. The invention's FIG. 2. on board wireless web server having a static or dynamic IP address connects to the internet 208 via a wireless WIFI network access point 204 or similar device. Access points typically contain an antenna 205, which broadcasts a signal 206, 203 to devices within the range, in this case the tanks antenna 119, 200. Access points typically connect to the internet via a land line 207. The server then waits for a player 404.

The player 402 logs onto the tanks web server via the Internet 401, which displays a HTML page 427. The web page is a combination of HTML, Java, AJAX, XML, CGI, E4X and XHTML commands. The web browser waits 425 for the user to click the power icon 309, the invention is now enabled 406. The system waits 409 for the player to press one of assigned keys.

Pressing the G key 407, increments the gear counter 408 up by 1 number, the players web page is updated 405 to reflect the new position of the gear lever 312 at position 1. Pressing the B key 410 decrements the gear counter by 1 411. Once the tank is in any gear but neutral, where the count equals 0, the tank can move depending on which key is pressed next. Pressing the Up Arrow Key 412, while the gear count is 2 413, enables the outputs to the drive motors 414, 415 at a rate of 60% full speed, the images for the track brakes 310, 311 are updated 429 to show the forward motion 313, 314. The tank moves forward at this rate, till the Up Arrow Key is released. The player continues pressing keys to control the tanks movement. Pressing other keys enables or disables the front and rear lights outputs while updated the players we page 306, 307 an assortment of devices could easily be added within the scope of this invention to enhance the players game, limited by the number of I/O available on the Wifi module.

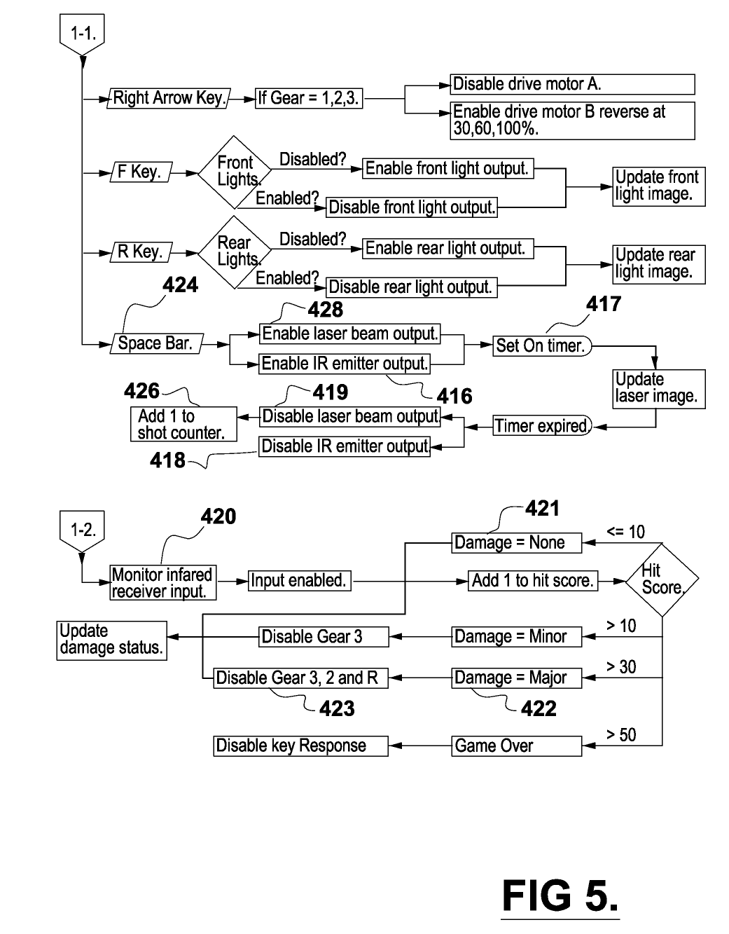

With the hook up to an output of a infrared emitter mounted inside the machine gun 117 and a hook up to an input with an in fared receiver, mounted on the tank, multiply tanks could be played in the same area and shots at each other could be recorded. If a second tank 201 (tank B) is in operation and controlled by another player (player B). Then player A pressing the FIG. 5. space bar 424 enables the outputs 428, 416 to a laser beam 104, mounted in the cannon 118 and in-fared emitter 103. The laser projects a beam, while updating the web page 308, for the player's amusement for a set amount of time 417 then, turns off the laser 419 and emitter 418, the shot counter 426 is incremented by 1 and the players web page updated 303. If the in-fared emitter signal is aimed at tank B, it is then detected by the in-fared receiver 102, and player B hits counter is incremented by 1. Should the tank B fire and tank A detects the signal 420 , then player A, hit score 304 is incremented by 1. A hit score of less than 10 sets the damage status 305 to none 421, should the hit score raise above 30 then, the damage status is changed to major 422 and the tank program disables the players ability to choose gears 3, 2 and Reverse 423. Should the damage counter raise above 50, then the tank is permanently disabled.

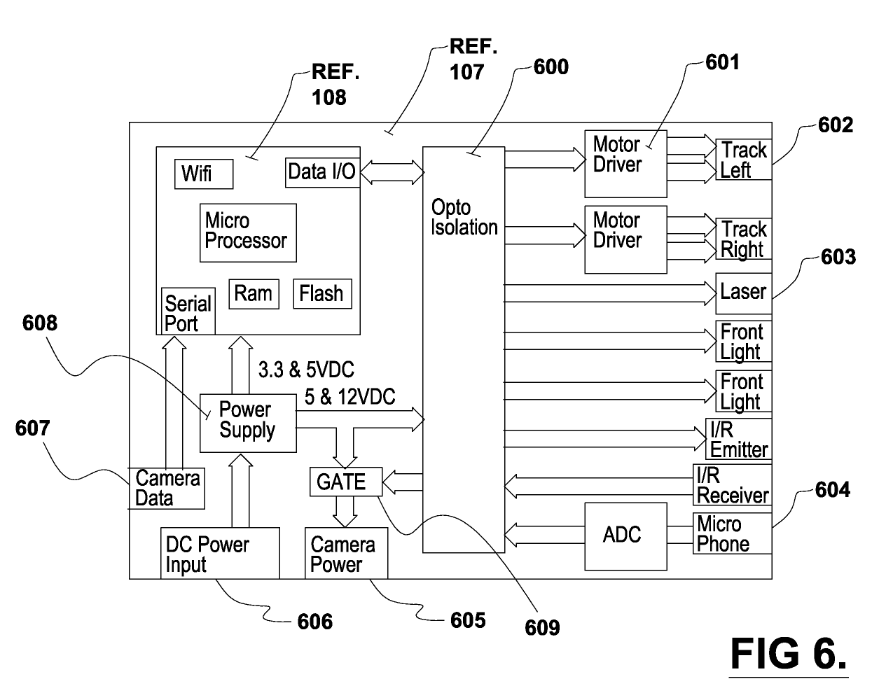

The custom motherboard 107, is designed in a manner to interface to the Wifi module 108. The motherboard FIG. 6. provides the needed power conversion 608 from the power source 606 to the module required voltages of 3.3 and 5 volts DC as well as power to the camera 605. Power to the camera is gated 609 via a transistor to enable or disable the camera. The motherboard contains connectors to interface the board to various motors, laser 603, lights etc. The Wifi module data I/O lines are optically isolated 600 using commonly available optocoupler IC's. The H-bridge DC motor ICs 601 such as one from Infinion Technologies part number TLE 5205-3 or equivalent have the plus and minus sides of DC motors 602 wired to them. Each motor ICs require two outputs from the motherboard, programming for the two outputs per the recommendation allows the tank track motors to rotate gears and drive shafts clockwise or anti-clockwise allowing the tank to move forward or backwards. The microphone provides analog data in 604, which is converted by a commonly available analog to digital convertor for transmission by the Wifi module. Data from the camera is received via the serial port 607, for transmission by the Wifi module to the player.

While it will apparent to those skilled in the art that this invention as disclosed pertaining to a scaled tank, this invention could easily be applied to various types of mobile scaled vehicles without departing from the scope or spirit of the invention. Thus, it is intended that the present invention cover the modifications and variations of this invention provided they come within the scope of the claims and their equivalents.

What is claimed is:

1. A scaled model tank controlled over a wireless TCP/IP network confirming to the IEEE 802.11 standards, commonly referred to as WiFi, such that the tank is controlled in real time.

2. A scaled model tank according to claim 1 encompassing a wireless web server.

3. A motherboard according to claim 2 with at least one digital input, one digital output, one serial port and two DC motor circuits to rotate clockwise or counter clockwise the DC motor(s) of the tank tracks, which allows the tank to move forward, backwards and spin in place.

4. A scaled model tank according to claim 1 with at least one real time video camera mounted in such a location such that the panoramic view of the camera includes the front fenders of the tank.

5. A scaled model tank according to claim 1 with at least one real time microphone.

6. A scaled model tank according to claim 1 with at least one infrared emitter.

7. A scaled model tank according to claim 1 with at least one infrared receiver.

8. A scaled model tank according to claim 1 with a laser beam.

9. A web browser application according to claim 1, to interact with web server.
